(19) United States
(12) Patent Application Publication
(10) Pub. No.: US 2025/0230843 A1
(43) Pub. Date: Jul. 17, 2025

(54) Universal Joint With Emergency Operating Properties and Joint Shaft and Motor Vehicle Comprising the Universal Joint

(71) Applicant: Bayerische Motoren Werke Aktiengesellschaft, Muenchen (DE)

(72) Inventors: Manuel GLOCKER, Haar (DE); Markus JETZINGER, Muenchen (DE); Helmut MUELLER, Toeging (DE)

(21) Appl. No.: 18/853,826

(22) PCT Filed: Mar. 6, 2023
(86) PCT No.: PCT/EP2023/055590

§ 371 Date: Oct. 3, 2024

(30) Foreign Application Priority Data
Apr. 4, 2022 (DE) 10 2022 107 934.1

(51) Int. Cl. F16D 3/38

(52) U.S. Cl. CPC F16D 3/385; F16D 3/387

(57) ABSTRACT

A universal joint includes two joint forks and a pin cross. The pin cross has a central body and four pins, which project in a common plane from the central body in two directions perpendicularly to one another, and each have a bearing point at which the respective pin is mounted in a respective corresponding fork bore of the joint forks. Next to at least one of the pins, at least one protrusion is formed which protrudes beyond the respective pin perpendicularly to its central longitudinal axis and has at least one stop face, which stands perpendicularly to a common plane and serves as a stop. Only in an event of fault of a bearing of the respective pin, for supporting the pin cross on an inner side, facing the pin cross, of the corresponding joint fork in order to limit a shift of the pin cross relative to the corresponding joint fork along a central longitudinal axis of the respective pin.

### SUMMARY AND BACKGROUND

The present disclosure concerns a universal joint and a corresponding jointed shaft and a motor vehicle equipped therewith.

Cardan or universal joints and corresponding jointed shafts are used in various applications, e.g. for motor vehicles or similar. There, the universal joints are often subjected to high loads. For example, DE 10 2008 049 348 A1 describes a cardan joint arrangement for a jointed shaft. The cardan joint arrangement there guarantees a maximum service life even in heavy-duty jointed shafts, while taking up minimum installation space. For this, a bearing device for pins of a pin cross is provided in a fork bore of a joint fork. The bearing device comprises a thrust bearing and a radial bearing for the pin, wherein the thrust bearing is arranged in the region of the pin shoulder. The fork bore has a contact collar on its side facing a rotational axis of the jointed shaft, while the pin shoulder has a contact face. The thrust bearing is arranged between the contact face and the contact collar. This ensures a minimum travel between the introduction of the force and the supporting of the thrust bearing, and allows an extremely robust thrust bearing support, wherein no additional contact rims are required for axial force support.

As a further example, DE 10 2012 109 475 B4 also describes a cardan joint assembly with two joint forks and four pin bearing arrangements. The latter comprise an outer sleeve which is arranged within a bearing bore of the joint forks and has an end face on a side facing a pin cross center. Furthermore, the pin bearing arrangements comprise an inner sleeve which is arranged inside the bearing bore and has a ring portion on a side facing the pin cross center. A thrust bearing is arranged between the end face of the outer sleeve and the ring portion of the inner sleeve. The outer sleeve is axially supported against the fork arm of the joint forks on a side of the bearing bore facing the pin cross center. The ring portion is arranged spaced from the pin cross so that in each case, a gap is present between the ring portion of the inner sleeve and the pin cross. This arrangement may achieve a minimum possible outer rotational diameter of the cardan joint assembly, while providing optimal support for the thrust bearing.

Such embodiments of cardan or universal joints may ensure improvements in regular, fault-free normal operation. However, bearings can be damaged or fail, i.e. suffer bearing failure. In such a case, the pin cross can shift relative to a joint fork, as one of the pins moves in its longitudinal direction further than the nominal or specified amount in fault-free normal operation, through the fork bore in the longitudinal direction of the pin. Then components of the universal joint may sweep or pass through a larger area than in fault-free normal operation, i.e. a rotational diameter of the universal joint may be enlarged. Thus the universal joint may for example come into contact with surrounding components and there cause further damage, or a clearance can be provided around the universal joint which is unnecessarily large for fault-free normal operation, which may mean an inefficient use of installation space in fault-free normal operation.

An object of the present disclosure is to indicate a possibility for implementing improved emergency operating properties of a universal joint in the case of failure of a bearing of a pin in a joint fork of the universal joint.

This and other objects are achieved according to the disclosure by the subject matter of the disclosure. Possible embodiments and refinements of the present disclosure are disclosed in the description and the figures.

The cardan or universal joint according to the disclosure may for example be provided, i.e. designed, for a jointed shaft or as part of a jointed shaft. The universal joint according to the disclosure comprises two joint forks and a pin cross. The pin cross has a central body and four pins, which—or the central longitudinal axes of which—project in a common plane outward from the central body in two directions standing perpendicularly to one another. The central body and the pins may be formed integrally or as one piece, or the pins may for example be received in corresponding receivers of the central body. Pins arranged along a common or the same pin central longitudinal axis may be separate elements or end pieces of a single cohesive pin component, which may then for example extend through the central body. The pins each have a bearing point at which the respective pin is mounted in a respective corresponding fork bore of the joint forks. Each of the joint forks may have two fork arms which are arranged on two mutually opposite sides of the pin cross and each have a fork bore in which one of the pins is mounted. The fork bores are thus receivers which may each surround as a ring one of the pins at its bearing point.

In the universal joint or as part of the universal joint, at least one protrusion is formed next to at least one of the pins. This protrusion protrudes beyond the respective pin perpendicularly to its central longitudinal axis. The protrusion has at least one stop face which stands perpendicularly to the common plane. This stop face serves as a stop, only in the event of fault of a bearing of the respective pin, for supporting the pin cross on an inner side, facing the pin cross, of the corresponding joint fork receiving the respective pin, in order to limit a shift of the pin cross relative to the corresponding joint fork along i.e. in the direction of the central longitudinal axis of the respective pin.

Viewed perpendicularly to the common plane in which the pins or their central longitudinal axes extend, i.e. in the projection into this plane, the protrusion may for example be formed in a region at a corner angle, lying in the plane, between the central longitudinal axes of two mutually adjacent pins.

Adjacent pins in the present sense are pins of which the central longitudinal axes stand perpendicularly to one another.

Viewed in the axial direction of the central longitudinal axis of the respective pin, the protrusion may in particular be arranged in front of and/or behind the bearing or a corresponding bearing point.

Only in the event of failure of the bearing can contact occur, as intended, at the protrusion between the pin cross and the corresponding joint fork, the bearing of which is damaged or has failed; while in fault-free normal operation of the universal joint with bearings functioning correctly or as specified, there is no such contact, i.e. no support of the pin cross on the joint fork via the protrusion.

The protrusion, provided additionally in this case in comparison with conventional universal joints, may in the event of bearing failure reduce or limit the scope i.e. extent of relative movability between the pin cross and the joint fork, so that in such a case the pin or pin cross cannot slip or be pushed too far through the fork bore of the fork. Thus, without a change in or loss of running properties of the universal joint in fault-free normal operation, it is possible to avoid or reduce an enlargement in the spatial volume swept or used by the universal joint in the event of fault, i.e. with a faulty, failed or destroyed bearing. Thus the present disclosure may allow a more efficient and compact design of installation space and an improvement in the emergency operating properties of the universal joint or corresponding jointed shaft in comparison with conventional universal joints or jointed shafts. The reduced or limited relative shift of the pin cross and joint forks may not only avoid damage to surrounding components, but for example also reduce imbalances and corresponding moments. This in turn may reduce the risk of further or permanent damage to the jointed shaft and/or other bearings.

Emergency operating properties of the universal joint in the present sense are the running properties or mechanical properties of the universal joint in the case of failure of a bearing, i.e. with at least one damaged, failed, or fully or partially destroyed bearing of a pin in the corresponding fork bore.

In a possible embodiment of the present disclosure, in fault-free normal operation in which the bearing functions correctly or as specified, a distance, in particular an air gap, is present in the region of the at least one protrusion, i.e. in the region of the stop provided for the case of fault or failure of the bearing, so that then there is no contact between the pin cross and the joint fork at the protrusion or the stop or stop face. Thus additional friction losses, in comparison with conventional universal joints, at the protrusion in fault-free normal operation can be avoided.

In a further possible embodiment of the present disclosure, the at least one protrusion is formed at least partially or completely or exclusively on the pin cross. Here the at least one protrusion may be formed in particular on the central body or as part of the central body. For example, the at least one protrusion may be formed at or on the far side of the pin shoulder or pin collar of the respective pin. Forming the at least one protrusion on the pin cross can allow particularly simple production. Also, in this way, an additional mass provided by the protrusion can be arranged particularly close to a rotational center point of the universal joint, so that a corresponding additional load on the universal joint can be kept particularly low.

In a further possible embodiment of the present disclosure, a corresponding protrusion is formed between and/or next to all pairs of adjacent pins. In other words, at least one respective protrusion is arranged between all pins or next to each pin. This may allow a particularly reliable support in various fault situations, i.e. on failure of or damage to any bearing. Also, in this way, a particularly symmetrical design of the universal joint can be achieved, which may e.g. lead or contribute to particularly smooth running in operation.

In a possible refinement of the present disclosure, viewed perpendicularly to the common plane, i.e. in the projection into the common plane, that is at the level of the central longitudinal axes of the pins, in each case a recess is formed between adjacent protrusions. In other words, the protrusions in the common plane do not have a cohesive form, i.e. do not form a continuous circle or complete square or continuous plateau, but are separated or spaced from one another. Thus, viewed in the circumferential direction about a central transverse axis of the pin cross standing perpendicularly to the common plane, there is an alternating or interrupted pattern of protrusions and recesses. These recesses may save material and weight. Also, the recesses may in some cases create or provide clearance for further components or materials or for a cooling air flow or similar. Also, the size of the stop face which, on a bearing failure, functions as a contact face between the pin cross and the respective joint fork, can thus be reduced, which can reduce corresponding friction losses. By corresponding choice of material for the protrusion however, sufficient strength of the protrusion can nonetheless be achieved to support the pin cross or bear the forces or loads occurring.

In a further possible embodiment of the present disclosure, the at least one protrusion is formed on both sides of the common plane. In other words, the protrusion or a respective protrusion may thus extend in both directions perpendicularly to the common plane. This allows a symmetrical design of the pin cross with respect to the common plane which constitutes a central cross-sectional plane of the pin cross. This may contribute to optimizing the smooth running of the universal joint and avoid or reduce a tilting of the pin cross or central longitudinal axis of the respective pin—the bearing of which is damaged or destroyed in the case of a fault—relative to the correct or specified position in fault-free normal operation. Such tilting could occur with unilateral support, i.e. if the protrusion were formed only on one side of the common plane, and potentially lead to an increased risk of further damage or to increased friction or loss of smooth running. This can be avoided or reduced by the design proposed here.

In a further possible embodiment of the present disclosure, a first stop face of the protrusion is formed perpendicularly to the central longitudinal axis of the respective pin, and a second stop face of the protrusion is formed perpendicularly to the central longitudinal axis of an adjacent pin, which itself stands perpendicularly to the central longitudinal axis of the first pin. This means that the two stop faces also stand perpendicularly to one another. Between these mutually perpendicular stop faces, the protrusion has a chamfer, i.e. a side which is chamfered relative to each of the two stop faces, which stands perpendicularly to the angle bisector of the corner angle between the central longitudinal axes of the two pins in the common plane. The chamfer, i.e. the chamfered side or outside, may thus e.g. stand at an angle of 45° to a respective one of the stop faces. The chamfer, i.e. the chamfered or oblique side, is thus neither perpendicular nor parallel to a central longitudinal axis of the pins. The design proposed here may be used in particular if the at least one recess is formed on the central body of the pin cross. The chamfer proposed here may allow a particularly simple installation of the pin cross or particularly simple assembly of the universal joint.

In a further possible embodiment of the present disclosure, the protrusion is formed at least partially on the inside of at least one of the joint forks. In other words, it is thus possible to form the protrusion fully or partially on the pin cross, or fully or partially on the joint fork. This gives corresponding flexibility in the design of the universal joint according to the disclosure, which can meet different requirements e.g. with respect to production, installation space or other properties. By forming the protrusion at least partially on at least one of the joint forks, in the case that only the pin cross is exchanged after a bearing failure, there is no need to replace material for the protrusion. Thus a cheaper maintenance or repair may be achievable.

By partially forming the protrusion on the pin cross or as part of the pin cross on one side, and on or as part of at least one of the joint forks on the other, it can be ensured particularly easily and reliably that, in the case of bearing failure, the contact or stop between the two parts of the protrusion comes about or takes place in the proposed correct fashion. Thus e.g. by correspondingly matched design and/or choice of material of the parts of the protrusion, a particularly low-friction emergency operation can be achieved, in particular without having to adapt accordingly the properties of other components or regions of the universal joint provided for fault-free normal operation.

A further aspect of the present disclosure is a jointed shaft having a first shaft piece and a second shaft piece, and a universal joint according to the disclosure which connects the two shaft pieces together. The jointed shaft according to the disclosure may in particular be or correspond to the jointed shaft described in connection with the universal joint according to the disclosure. Accordingly, the jointed shaft according to the disclosure may have some or all of the features and properties cited in connection with the universal joint according to the disclosure.

A further aspect of the present disclosure is a motor vehicle having at least one universal joint according to the disclosure and/or at least one jointed shaft according to the disclosure. The motor vehicle according to the disclosure may in particular be a motorcycle, but is not restricted thereto. A motor vehicle may constitute a particularly useful application for the jointed shaft according to the disclosure or the universal joint according to the disclosure, since improved emergency operating properties and a reduced risk of damage to surrounding components may lead to the motor vehicle being able, in the case of bearing failure, to continue travelling under its own power or its own drive as far as a workshop for example. Thus the present disclosure can achieve greater convenience of use and also reduce the costs incurred in the case of failure. Also, the improved emergency operating properties of the universal joint according to the disclosure or the jointed shaft according to the disclosure may improve safety during operation of the motor vehicle.

Further features of the disclosure may arise from the claims, the figures and the description of the figures. The features and feature combinations cited in the description, and the features and feature combinations disclosed below in the description of the figures and/or in the figures alone, may be used not only in the respective combination given but also in other combinations or alone without leaving the scope of the disclosure.

In the drawings:

### BRIEF DESCRIPTION OF THE DRAWINGS

FIG. 1 shows a schematic perspective illustration of a conventional pin cross for a universal joint according to the prior art;

FIG. 2 shows a schematic perspective illustration of an improved pin cross for a universal joint with improved emergency operating properties;

FIG. 3 shows a schematic side view of an improved universal joint;

FIG. 4 shows a schematic cross-sectional illustration of a conventional universal joint according to the prior art; and

FIG. 5 shows a schematic cross-sectional illustration of an improved universal joint.

### DETAILED DESCRIPTION OF THE DRAWINGS

In the figures, the same elements and those with equivalent function carry the same reference signs.

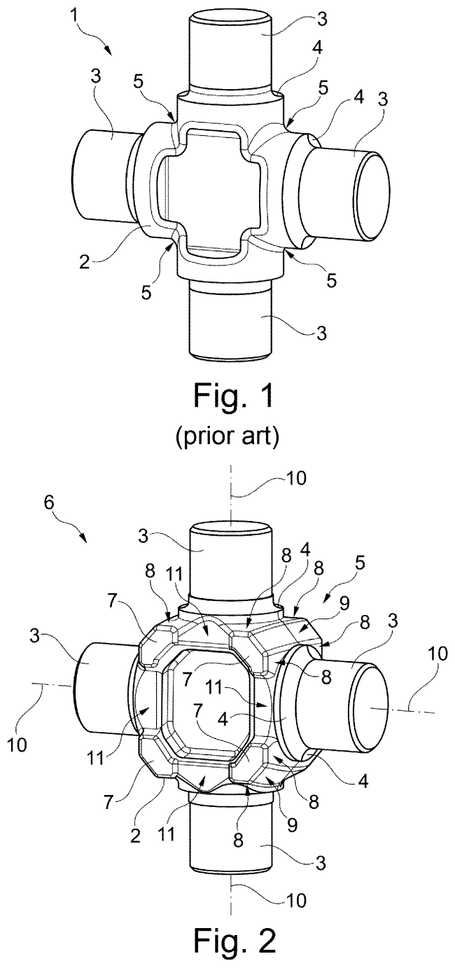

FIG. 1 shows a schematic, perspective illustration of a conventional, standard pin cross 1 according to the prior art. The standard pin cross 1 has a central body 2 and pins 3 protruding therefrom. The pins 3 lie in a common plane and extend in two directions lying in this common plane and standing perpendicularly to one another, so as to give a cross-shaped arrangement. The pins 3 each have a narrower region at the end and a wider pin collar or pin shoulder 4 arranged in the direction of the center point of the central body 2. The central body 2 of the standard pin cross 1 is cut back as far as possible, i.e. formed minimally, at each corner angle 5, i.e. in a corner region between two adjacent pins 3. Thus the standard pin cross 1 can slip through a respective receiver in the longitudinal direction of one of the pins 3, e.g. in the case of bearing failure. This is explained in more detail in connection with FIG. 4.

FIG. 2 shows a schematic, perspective illustration of a pin cross 6 which is improved in comparison with the standard pin cross 1. The pin cross 6 also has a central body 2 and four pins 3 protruding therefrom in a common plane in two directions standing perpendicularly to one another. In the pin cross 6, the central body 2 has a protrusion 7 at each corner angle 5, i.e. between two adjacent pins 3 or in a transitional region between two adjacent pin shoulders 4. These protrusions 7 protrude beyond the pins 3 perpendicularly to the common plane which forms a central cross-sectional plane of the pin cross 6. Thus the protrusions 7 form stops or stop faces 8 which are arranged or extend at least substantially perpendicularly to the common plane of the pins 3.

As a result, in the case of a bearing failure, the pin cross 6 cannot slip as far as the standard pin cross 1 through a corresponding receiver or pin bearing of one of the pins 3 before the adjacent pins 3 stop on another component. Rather, this slipping, i.e. the movement of the pin cross 6 in the longitudinal direction of one of the pins 3, is limited by the protrusions 7, in particular is possible only until the respective stop face 8 extending perpendicularly to the movement direction, i.e. the longitudinal direction of one of the pins 3, comes to a stop, i.e. makes contact with another component.

The protrusions 7 are here equipped with a respective chamfer 9 which stands obliquely, in particular at an angle different from 0° and 90°, in particular at an angle of 45°, to the stop faces 8 of the respective protrusion 7. Thanks to this chamfer 9 in the region of the respective corner angle 5, installation of the pin cross 6 may be simplified.

For further illustration, here the central longitudinal axes 10 of the pins 3 are indicated. The central longitudinal axes 10 lie in said common plane and intersect at the center point of the pin cross 6 or central body 2.

To the side, i.e. viewed perpendicularly to the common plane or central longitudinal axes 10, the protrusions 7 are arranged on the respectively observed side of the pin cross 6 or central body 2, on the line of a theoretical circle or theoretical square. Viewed along this line, the protrusions 7 are spaced from one another by intermediate recesses 11. The recesses 11 are each arranged in the region of one of the pins 3, i.e. at the height of one of the central longitudinal axes 10, while the protrusions 7 are arranged in-between, that is between the pins 3, i.e. in the corners or corner angles between the center longitudinal axes 10. The recesses 11 may be useful e.g. for saving material and weight, and for creating access or a guide facility. Here, the design or arrangement illustrated is however exemplary, so that other arrangements or designs may also be possible. For example, the recesses 11 may be omitted in order to enlarge the stop faces 8; additional protrusions 7 may be provided in the recesses 11, and/or additional recesses 11 in the region of the protrusions 7 shown, and/or as so on.

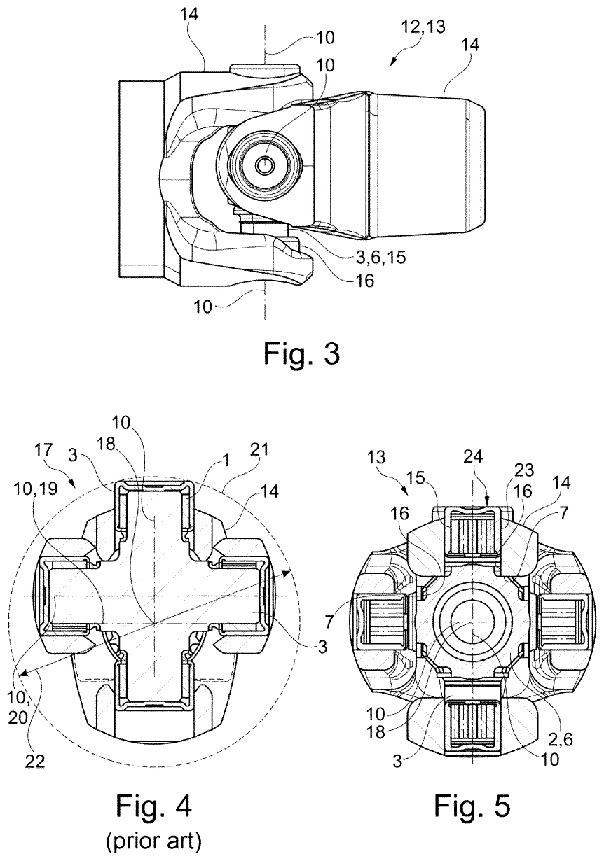

FIG. 3 shows in extract a schematic side view of a jointed shaft 12 with a correspondingly improved universal joint 13. The universal joint 13 here comprises the pin cross 6 and two joint forks 14. The joint forks 14 each have two joint arms which receive or hold pins 3 arranged on opposite sides of the central body 2.

In the situation of a bearing failure shown here, one of the joint forks 14 has shifted upward along the central longitudinal axis 10 running into the drawing plane. This exposes i.e. reveals a bearing point 15 of the opposite pin.

In the design shown here, the joint forks 14 also have protrusions 16 on the forks which have the same purpose as the above-described protrusions 7 of the pin cross 6. For example, on bearing failure, the protrusion 16 on the fork can stop on the corresponding stop face 8, i.e. be supported there, so as to prevent a further shift of the pin cross 6 relative to the joint forks 14.

FIG. 4 shows a schematic cross-sectional illustration of a standard universal joint 17 with bearing damage. The drawing shows a nominal center point 18 at which the center longitudinal axes 10 of the pins 3 intersect in fault-free normal operation. This is illustrated here by an indicated nominal position 19 of one of the central longitudinal axes 10, at which the corresponding central longitudinal axis 10 runs through the nominal center point 18. In contrast, in the failure case illustrated here, the standard pin cross 1 has shifted along one of the central longitudinal axes 10 relative to the joint forks 14, so that the second central longitudinal axis 10 running perpendicularly thereto is now in a parallel-shifted position 20 relative to the nominal position 19. Thus the standard pin cross 1 has been substantially deflected out of its correct position. This inevitably leads to an enlargement of the indicated outer rotational circle 21.

The outer rotational circle 21 comprises or identifies the spatial region which is swept or passed on a rotation of the standard universal joint 19 about its rotational axis, which here stands perpendicularly to the drawing plane. The shift of the standard pin cross 8 therefore increases the diameter 22 of the outer rotational circle 21, so that in a corresponding fault case, the standard universal joint 17 requires more space or can come into undesired contact with surrounding components.

Thanks to the described structural measures on the improved pin cross 6 and/or the joint forks 14, on failure of a bearing of one of the pins 3, the outer rotational circle 21 or its diameter 22 resulting from fault-free normal operation may be at least approximately retained, or its enlargement at least reduced in comparison with the standard universal joint 17. This may be achieved by corresponding webs or moldings, i.e. the protrusions 7 and/or the fork-side protrusions 16. Here, FIG. 5 shows a schematic cross-sectional view of the universal joint 13 in a corresponding fault case. On corresponding damage or failure of the bearing, the pin cross 6 can then be supported on these webs or protrusions 7, 16 within the jointed shaft forks 14. Thus despite the damage to or failure of the bearing and the associated, at least potential shift of the pin cross 6 relative to the joint forks 14, the rotational diameter of the universal joint 13 or corresponding jointed shaft 12 is not or is only slightly enlarged. This may avoid the corresponding pin 3 being moved or shifted outward through the respective fork bore 23. In other words, this may prevent a pin end 24 of the corresponding pin 3 from coming into contact with surrounding components and causing consequential damage.

Overall, the examples described here show how an improvement in emergency operating properties of a cardan or universal jointed shaft can be achieved.

### LIST OF REFERENCE SIGNS

1 Standard pin cross
2 Central body
3 Pin
4 Pin shoulder
5 Corner angle
6 Pin cross
7 Protrusion
8 Stop face
9 Chamfer
10 Central longitudinal axis
11 Recess
12 Jointed shaft
13 Universal joint
14 Joint fork
15 Bearing point
16 Fork-side protrusion
17 Standard universal joint
18 Nominal center point
19 Nominal position
20 Shifted position
21 Outer rotational circle
22 Diameter
23 Fork bore
24 Pin end

1.-10. (canceled)

11. A universal joint comprising:
two joint forks; and
a pin cross with a central body and four pins, which project in a common plane from the central body in two directions perpendicularly to one another, and each have a bearing point at which the respective pin is mounted in a respective corresponding fork bore of the joint forks, wherein
next to at least one of the pins, at least one protrusion is formed which protrudes beyond the respective pin perpendicularly to its central longitudinal axis and has at least one stop face, which stands perpendicularly to a common plane and serves as a stop, only in an event of fault of a bearing of the respective pin, for supporting the pin cross on an inner side, facing the pin cross, of the corresponding joint fork in order to limit a shift of the pin cross relative to the corresponding joint fork along a central longitudinal axis of the respective pin.

12. The universal joint according to claim 11, wherein in fault-free normal operation, an air gap distance, is present in a region of the protrusion so that there is no contact between the pin cross and the joint fork at the protrusion.

13. The universal joint according to claim 11, wherein the protrusion is formed at least partially on the central body of the pin cross.

14. The universal joint according to claim 11, wherein a corresponding protrusion is formed between and/or next to all adjacent pins.

15. The universal joint according to claim 13, wherein viewed perpendicularly to the common plane, a recess is formed between adjacent protrusions along the central longitudinal axes of the pins.

16. The universal joint according to claim 11, wherein the protrusion is formed on both sides of the common plane.

17. The universal joint according to claim 11, wherein a first stop face of the protrusion is formed perpendicularly to the central longitudinal axis of the respective pin, a second stop face of the protrusion is formed perpendicularly to the central longitudinal axis of an adjacent pin, and between these stop faces, the protrusion has a chamfer which stands perpendicularly to the angle bisector of the corner angle between the central longitudinal axes of the two pins in the common plane.

18. The universal joint according to claim 11, wherein the protrusion is formed at least partially inside of at least one of the joint forks.

19. A jointed shaft comprising:
a first shaft piece;
a second shaft piece; and
the universal joint according to claim 11 which connects the first shaft piece and the second shaft piece together.

20. A motor vehicle comprising:
the universal joint according to claim 11.

21. A motor vehicle comprising:
the jointed shaft according to claim 19.
